(19) United States
(12) Patent Application Publication
(10) Pub. No.: US 2010/0094762 A1
(43) Pub. Date: Apr. 15, 2010

(54) SYSTEM AND METHOD FOR RATING AND RANKING MUSIC QUALITY USING SURVEY QUESTIONNAIRES

(76) Inventor: Douglas F. Ruhe, Newburgh, NY (US)

Correspondence Address: KASHA LAW LLC, 14532 Dufief Mill Road, North Potomac, MD, 20878, US

(21) Appl. No.: 12/250,140

(22) Filed: Oct. 13, 2008

(51) Int. Cl. G06Q 99/00

(52) U.S. Cl. 705/306

(57) ABSTRACT

A piece of recorded music is ranked relative to other pieces of recorded music. The piece of music is received from a user. The piece of music is categorized into at least one genre. A group of reviewers is selected to rate at least one artistic quality of the piece of the piece of music and a survey questionnaire is selected. The piece of music and the survey questionnaire are sent to the group of reviewers to be rated by each reviewer in the group using the survey questionnaire. Two or more completed survey questionnaires are received from the group of reviewers for the piece of music. A quality rating is calculated for the piece of music based on the two or more completed survey questionnaires received. The piece of music is ranked relative to other pieces of music based on the quality rating.

### INTRODUCTION

The music market is fragmenting as consumers switch from buying compact discs (CDs) to downloading single songs. The sales of major label producers continue to fall, while sales at websites that provide downloads of music continue to climb.

Unfortunately, however, the most popular websites that provide music downloads primarily sell the music of major label artists. In fact, almost all online music vendors sell the same music, produced by the major labels, for about the same price. Savvy music fans, however, know that all major label commercial artists started as independents. Also, some commercially successful bands have left their major labels and used the Internet to sell their music directly to fans.

There are, therefore, large numbers of artists whose music is not available through the large online music vendors. This music is sometimes referred to as the “Long Tail” of independent music. Presently, there are millions of independent songs, in every genre, posted haphazardly online. These independent songs represent a spectrum of quality that makes it difficult for music fans to find good music online.

### BRIEF DESCRIPTION OF THE DRAWINGS

The skilled person in the art will understand that the drawings, described below, are for illustration purposes only. The drawings are not intended to limit the scope of the applicant's teachings in any way.

FIG. 1 is a flowchart showing a method for rating and ranking a piece of recorded music relative to other pieces of recorded music, in accordance with the present teachings.

FIG. 2 is a schematic diagram showing a system for rating and ranking a piece of recorded music relative to other pieces of recorded music, in accordance with the present teachings.

FIG. 3 is a flowchart showing a method for rating and ranking a piece of recorded artistic media relative to other pieces of recorded artistic media, in accordance with the present teachings.

Before one or more embodiments of the invention are described in detail, one skilled in the art will appreciate that the invention is not limited in its application to the details of construction, the arrangements of components, and the arrangement of steps set forth in the following detailed description or illustrated in the drawings. The invention is capable of other embodiments and of being practiced or being carried out in various ways. Also, it is to be understood that the phraseology and terminology used herein is for the purpose of description and should not be regarded as limiting.

### DESCRIPTION OF VARIOUS EMBODIMENTS

The section headings used herein are for organizational purposes only and are not to be construed as limiting the subject matter described in any way.

In various embodiments, methods and systems enable independent musicians to have their music listened to and evaluated online by fans of new music. Fans are recruited for various genres of music. These genres can include, but are not limited to, country, rhythm and blues (R&B), rock, folk, and hip-hop. The recruited music fans serve as arbiters. Arbiters or reviewers evaluate each song using the same quality criteria. These evaluations generate numerical ratings. These ratings are the basis for ranking the songs on genre specific charts.

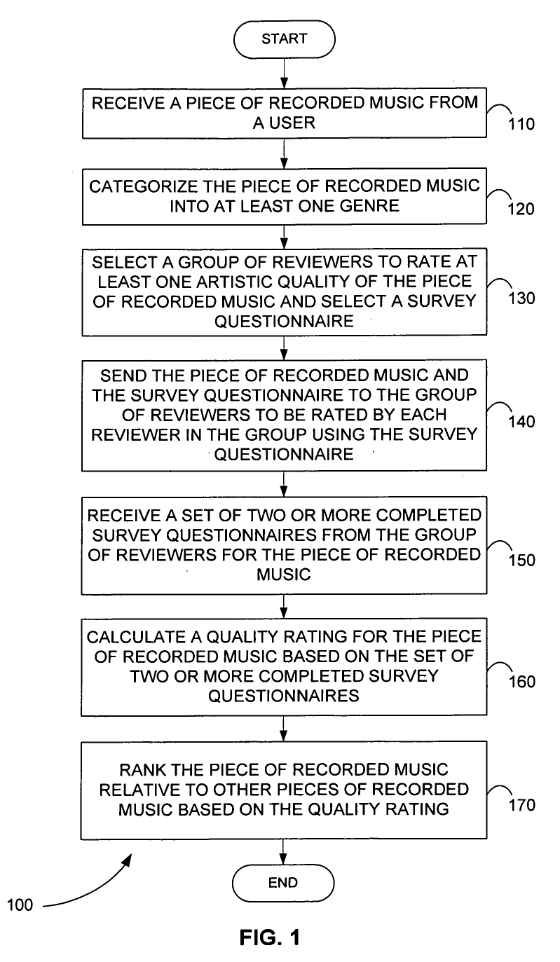

FIG. 1 is a flowchart showing a method 100 for rating and ranking a piece of recorded music relative to other pieces of recorded music, in accordance with the present teachings.

In step 110 of method 100, a piece of recorded music is received from a user. The recorded music can include lyrics and melody or just melody. The user can be, but is not limited to, a composer of the piece of recorded music or a music fan that collected the piece of recorded music. The piece of recorded music can be recorded by digital or analog means, for example.

In step 120, the piece of recorded music is categorized into at least one genre. The genre can be, but is not limited to, country, rhythm and blues (R&B), rock, folk, and hip-hop.

In step 130, a group of reviewers is selected to rate at least one artistic quality of the piece of recorded music and a survey questionnaire is selected. Both the group and the survey questionnaire are selected based on the at least one genre found in step 120. The reviewers selected for the group can be, but are not limited to, volunteer music listeners, paid employees, or skilled music experts. The reviewers can be randomly selected for the group, for example. The survey questionnaire can include one or more ratings related to aspects of the piece of recorded music. The aspects can include, but are not limited to, lyrics, melody, vocal performance, instrumental performance, and rhythm. In various embodiments, the at least one artistic quality of the piece of recorded music and the aspects can include popularity. For example, the group of reviewers can be selected based on their knowledge of the popularity of music. The selected group of reviewers then rates and ranks the piece of recorded music based on their opinion of popularity.

In step 140, the piece of recorded music and the survey questionnaire are sent to the group of reviewers to be rated by each reviewer in the group using the survey questionnaire. The piece of recorded music can be sent to the group of reviewers in digital form, for example.

In step 150, a set of two or more completed survey questionnaires are received from the group of reviewers for the piece of recorded music.

In step 160, a quality rating is calculated for the piece of recorded music based on the set of two or more completed survey questionnaires received in step 140. In various embodiments, a score for each completed survey questionnaire of the set of two or more completed survey questionnaires is obtained and all the scores are summed to produce the quality rating.

In step 170, the piece of recorded music is ranked relative to other pieces of recorded music based on the quality rating. The other pieces of recorded music may receive quality ratings earlier according to method 100, for example.

In various embodiments, a chart can be created to depict the ranking found in step 170. In various embodiments, the ranking can be displayed on a website on the Internet.

In various embodiments, method 100 can be used to rank large numbers of pieces of recorded music in each genre. The following steps illustrate ranking a second piece of recorded music after the steps of method 100 have been executed. The second piece of recorded music is received from a second user. The second piece of recorded music is categorized into the same genre as the piece of recorded music ranked in method 100. A second group of reviewers is selected to rate at least one artistic quality of the second piece of recorded music. The second group is selected based on genre. The survey questionnaire selected is the same survey questionnaire selected in method 100. The second group is selected to have a same number of reviewers as the group selected in method 100.

The second piece of recorded music and the survey questionnaire are sent to the second group to be rated by each reviewer in the second group using the survey questionnaire. A second set of two or more completed survey questionnaires are received from the second group for the second piece of recorded music. The set of two or more completed survey questionnaires found in method 100 and the second set of two or more completed survey questionnaires have the same set of quality criteria for rating digital music of the same genre, for example. A second quality rating is calculated for the second piece of recorded music based on the second set of two or more completed survey questionnaires. The second piece of recorded music is ranked relative to the piece of recorded music received in method 100 and other pieces of recorded music based on the second quality rating.

In various embodiments, method 100 can be used to prevent the evaluation of a piece of recorded music under false pretences. For example, method 100 can analyze the piece of recorded music received in step 110 for copyright codes. If any copyright codes are found, the piece of recorded music is not rated or ranked. Analyzing the piece of recorded music can include comparing digital data to known copyright codes, for example.

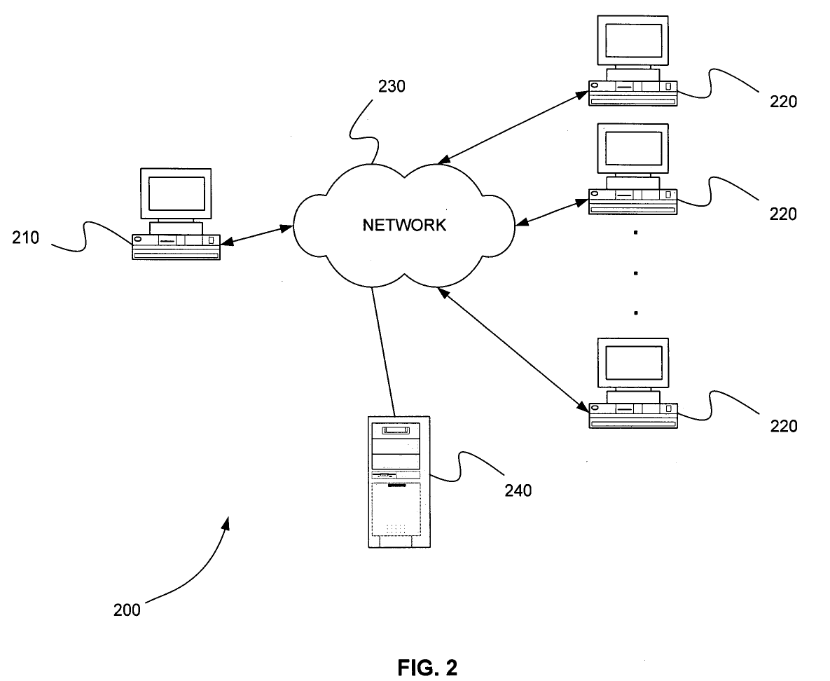

FIG. 2 is a schematic diagram showing a system 200 for rating and ranking a piece of recorded music relative to other pieces of recorded music, in accordance with the present teachings. System 200 includes client 210, two or more clients 220, network 230, and server 240. Client 210 stores a piece of recorded music. Two or more clients 220 are accessible to a group of reviewers. Server 240 is connected to client 210 and two or more clients 220 through network 230. Server 240 can be a web server, client 210 can be a web client, two or more clients 220 can be two or more web clients, and network 230 can be the Internet, for example.

Server 240 receives the piece of recorded music from client 210. Server 240 categorizes the piece of recorded music into at least one genre and selects the group of reviewers to rate at least one artistic quality of the piece of recorded music and selects a survey questionnaire. Both the group and the survey questionnaire are selected based on the genre the piece of recorded music is placed into.

Server 240 sends the piece of recorded music and the survey questionnaire to two or more clients 220 where the piece of recorded music is rated by each reviewer in the group using the survey questionnaire. The survey questionnaire is displayed on a web browser on two or more clients 220, for example. Server 240 receives from two or more clients 220 a set of two or more completed survey questionnaires from the group of reviewers for the piece of recorded music. Server 240 calculates a quality rating for the piece of recorded music based on the set of two or more completed survey questionnaires and ranks the piece of recorded music relative to the other pieces of recorded music based on the quality rating.

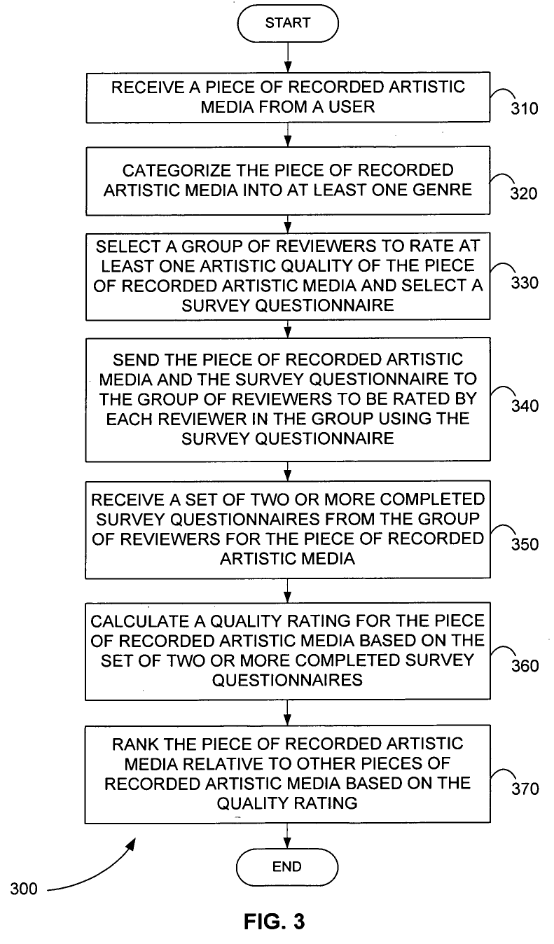

In addition to recorded music, method 100 can be used to rate and rank other pieces of recorded artistic media. FIG. 3 is a flowchart showing a method 300 for rating and ranking a piece of recorded artistic media relative to other pieces of recorded artistic media, in accordance with the present teachings.

In step 310 of method 300, a piece of recorded artistic media is received from a user. A piece of recorded artistic media can include, but is not limited to, a recorded image of a painting, a recorded image of a drawing, a recorded image of a photograph, a recorded video, or recorded audio. Recorded audio can include the reading of a book, for example. The piece of recorded artistic media can be recorded by digital or analog means, for example.

In step 320, the piece of recorded artistic media is categorized into at least one genre.

In step 330, a group of reviewers is selected to rate at least one artistic quality of the piece of recorded artistic media and a survey questionnaire is selected. The group of reviewers and the survey questionnaire are selected based on the at least one genre.

In step 340, the piece of recorded artistic media and the survey questionnaire are sent to the group of reviewers to be rated by each reviewer in the group using the survey questionnaire. The piece of recorded artistic media can be sent to the group of reviewers in digital form, for example.

In step 350, a set of two or more completed survey questionnaires is received from the group of reviewers for the piece of recorded artistic media.

In step 360, a quality rating is calculated for the piece of recorded artistic media based on the set of two or more completed survey questionnaires.

In step 370, the piece of recorded artistic media is ranked relative to the other pieces of recorded artistic media based on the quality rating.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

While the applicants' teachings are described in conjunction with various embodiments, it is not intended that the applicants' teachings be limited to such embodiments. On the contrary, the applicants' teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A computer-implemented method for rating and ranking a piece of recorded music relative to other pieces of recorded music, comprising:
receiving the piece of recorded music from a user;
categorizing the piece of recorded music into at least one genre;
selecting a group of reviewers to rate at least one artistic quality of the piece of recorded music and selecting a survey questionnaire, wherein the group and the survey questionnaire are selected based on the at least one genre;
sending the piece of recorded music and the survey questionnaire to the group to be rated by each reviewer in the group using the survey questionnaire;
receiving a set of two or more completed survey questionnaires from the group for the piece of recorded music;
calculating a quality rating for the piece of recorded music based on the set of two or more completed survey questionnaires; and
ranking the piece of recorded music relative to the other pieces of recorded music based on the quality rating.

2. The method of claim 1, wherein the group comprises volunteer music listeners.

3. The method of claim 1, wherein the user comprises a composer of the piece of recorded music.

4. The method of claim 1, wherein the user comprises a fan that collected the piece of recorded music.

5. The method of claim 1, wherein the at least one genre comprises one of country, rhythm and blues (R&B), rock, folk, and hip-hop.

6. The method of claim 1, wherein the selecting the group of reviewers includes randomly selecting reviewers for the group.

7. The method of claim 1, wherein the survey questionnaire comprises a rating related to at least one of lyrics, melody, vocal performance, instrumental performance, and rhythm.

8. The method of claim 1, wherein the calculating the quality rating for the piece of recorded music based on the set of two or more completed survey questionnaires comprises summing a numerical score for each completed survey questionnaire of the set of two or more completed survey questionnaires to produce the quality rating.

9. The method of claim 1, further comprising:
creating a chart to depict the ranking.

10. The method of claim 1, further comprising:
displaying the ranking on a website on the Internet.

11. The method of claim 1, further comprising:
receiving a second piece of recorded music from a second user;
categorizing the second piece of recorded music into the at least one genre;
selecting a second group of reviewers to rate at least one artistic quality of the second piece of recorded music and selecting the survey questionnaire, wherein the second group and the survey questionnaire are selected based on the at least one genre, and wherein the group and the second group have a same number of reviewers;
sending the second piece of recorded music and the survey questionnaire to the second group to be rated by each reviewer in the second group using the survey questionnaire;
receiving a second set of two or more completed survey questionnaires from the second group for the second piece of recorded music;
calculating a second quality rating for the second piece of recorded music based on the second set of two or more completed survey questionnaires; and
ranking the second piece of recorded music relative to the piece of recorded music and the other pieces of recorded music based on the second quality rating.

12. The method of claim 11, wherein the set of two or more completed survey questionnaires and the second set of two or more completed survey questionnaires include a same set of quality criteria for rating digital music of a same genre.

13. A system for rating and ranking a piece of recorded music relative to other pieces of recorded music, comprising:
a client that stores the piece of recorded music;
two or more clients accessible to a group of reviewers;
a network; and
a server connected to the client and the two or more clients through the network that
receives the piece of recorded music from the client,
categorizes the piece of recorded music into at least one genre,
selects the group of reviewers to rate at least one artistic quality of the piece of recorded music and selects a survey questionnaire, wherein the group and the survey questionnaire are selected based on the at least one genre;
sends the piece of recorded music and the survey questionnaire to the two or more clients where the piece of recorded music is rated by each reviewer in the group using the survey questionnaire,
receives from the two or more clients a set of two or more completed survey questionnaires from the group for the piece of recorded music,
calculates a quality rating for the piece of recorded music based on the set of two or more completed survey questionnaires, and
ranks the piece of recorded music relative to the other pieces of recorded music based on the quality rating.

14. The system of claim 13, wherein the server comprises a web server, the network comprises the Internet, the client comprises a web client, and the two or more clients comprise two or more web clients.

15. The system of claim 13, wherein the survey questionnaire is displayed on a web browser on the two or more clients.

16. A computer-implemented method for rating and ranking a piece of recorded artistic media relative to other pieces of recorded artistic media, comprising:
receiving the piece of recorded artistic media from a user;
categorizing the piece of recorded artistic media into at least one genre;
selecting a group of reviewers to rate at least one artistic quality of the piece of recorded artistic media and selecting a survey questionnaire, wherein the group and the survey questionnaire are selected based on the at least one genre;
sending the piece of recorded artistic media and the survey questionnaire to the group to be rated by each reviewer in the group using the survey questionnaire;
receiving a set of two or more completed survey questionnaires from the group for the piece of recorded artistic media;
calculating a quality rating for the piece of recorded artistic media based on the set of two or more completed survey questionnaires; and
ranking the piece of recorded artistic media relative to the other pieces of recorded artistic media based on the quality rating.

17. The method of claim 16, wherein the piece of recorded artistic media comprises a recorded image of a painting.

18. The method of claim 16, wherein the piece of recorded artistic media comprises a recorded image of a drawing.

19. The method of claim 16, wherein the piece of recorded artistic media comprises a recorded image of a photograph.

20. The method of claim 16, wherein the piece of recorded artistic media comprises a recorded video.
